(19) United States
(12) Patent Application Publication
(10) Pub. No.: US 2013/0112154 A1
(43) Pub. Date: May 9, 2013

(54) BRIDLE MUZZLE

(71) Applicant: Nancy Sheridan, Brewster, MA (US)

(72) Inventor: Nancy Sheridan, Brewster, MA (US)

(21) Appl. No.: 13/288,372

(22) Filed: Nov. 3, 2011

(51) Int. Cl. A01K 25/00

(52) U.S. Cl. 119/832

(57) ABSTRACT

A device to prevent a horse from eating which is easily attached to a bridle; allows free air flow for breathing; allows normal control of the horse by the bridle; and does not interfere with the bridle's bit.

### BACKGROUND

Existing masks/muzzles are used when a horse is not being ridden. They prevent a horse from over eating while in a stall, pasture, or paddock and are designed to attach to a halter.

They cannot be worn with a bridle because it is too heavy and cumbersome and cannot fit around a bit on a horses bridle.

The grazing mask is designed for the purpose of withstanding many consecutive hours of use on a grazing horse on a daily basis.

Grazing Masks are made from heavy strapping interwoven to create spaces large enough for the horse to draw grass/hay through, sometimes with heavy rubber/plastic reinforcement in the areas meant to withstand the constant pressure & friction generated by an actively grazing horse.

Grazing Masks are meant to be worn on a halter, when the horse is at liberty in the stall or pasture. The attachment systems are robust and are meant to give way only under extreme pressure.

### SUMMARY

There is a need for a muzzle which can be used when a horse is being ridden. This will prevent a horse from eating while being ridden, driven, or worked in hand.

The bridle muzzle is designed to attach to a bridle and provides a sturdy lightweight design fitted around the horses bit without any interference of breathing or control of the horse. The bridle muzzle prevents a horse from “snacking” while under saddle. And can be used temporarily as a training aid to teach a horse not to eat when bridled or can be used constantly during riding to keep your riding “wrestle” free.

Bridle masks are constructed form lightweight mesh allowing for maximum airflow and will not interfere with the horse's breathing, while the tiny openings in the mesh eliminate any possibility of the horse drawing grass or leaves into his mouth while in work. The mask is designed with lowered sides so that it does not interfere with the action of the bit. Bridle Masks are meant to be worn with a bridle, wherever and whenever the horse is being worked. The attachment system is simple and will quickly & securely attach to any noseband, yet will give way under firm pressure, ensuring the safety of both horse and rider/handler.

It provides the following benefits:

Designed for the comfort and safety of the horse.

Will not interfere with bit.

Does not interfere with control of the horse.

Does not inhibit breathing.

Allows horse to easily snort out bugs.

Straps with fasteners designed to allow rapid easy release so horse will not panic if mask gets caught.

Durable, tear resistant.

Easy to maintain.

Can be utilized on all horses, including drafts and ponies.

Safer and more effective than grass reins.

### BRIEF DESCRIPTION OF DRAWINGS

FIG. 1 is a front perspective view of the bridle muzzle.

FIG. 2 is a front view of the bridle muzzle attached to the bridle on a horse.

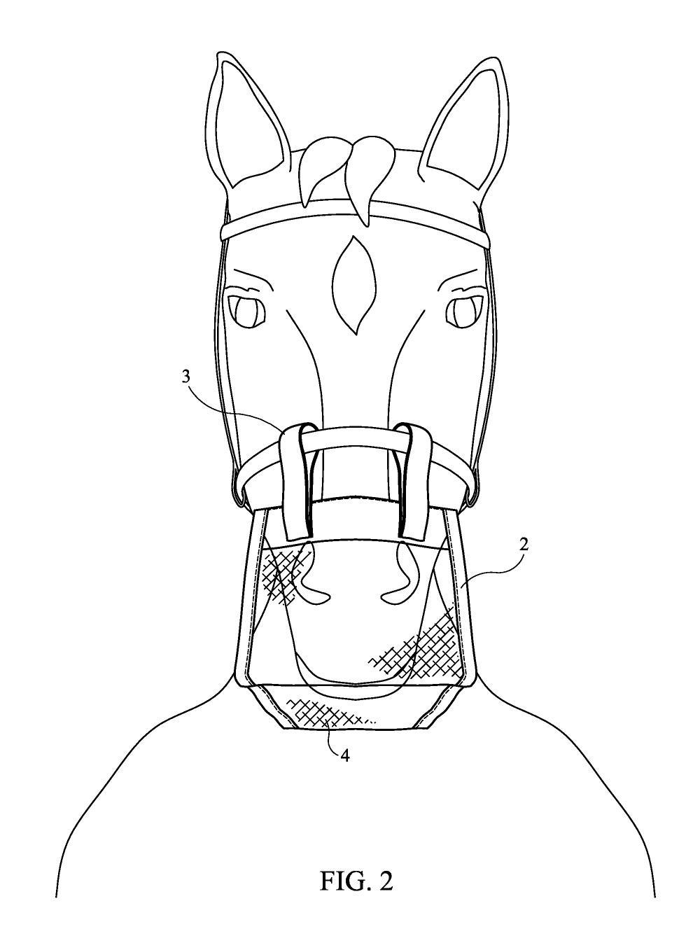

FIG. 3 is a side view of the bridle muzzle attached to the bridle on a horse.

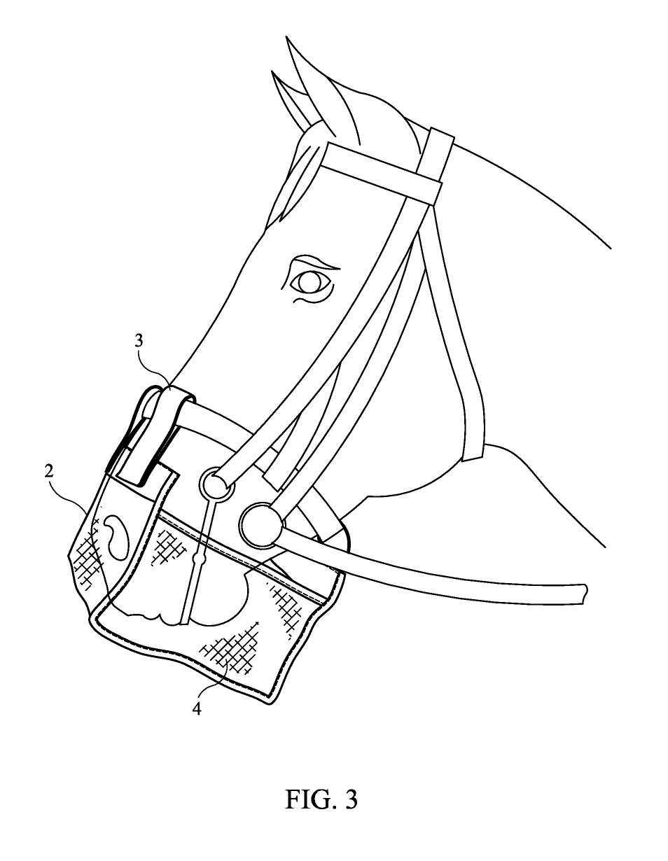

### DETAILED DESCRIPTION

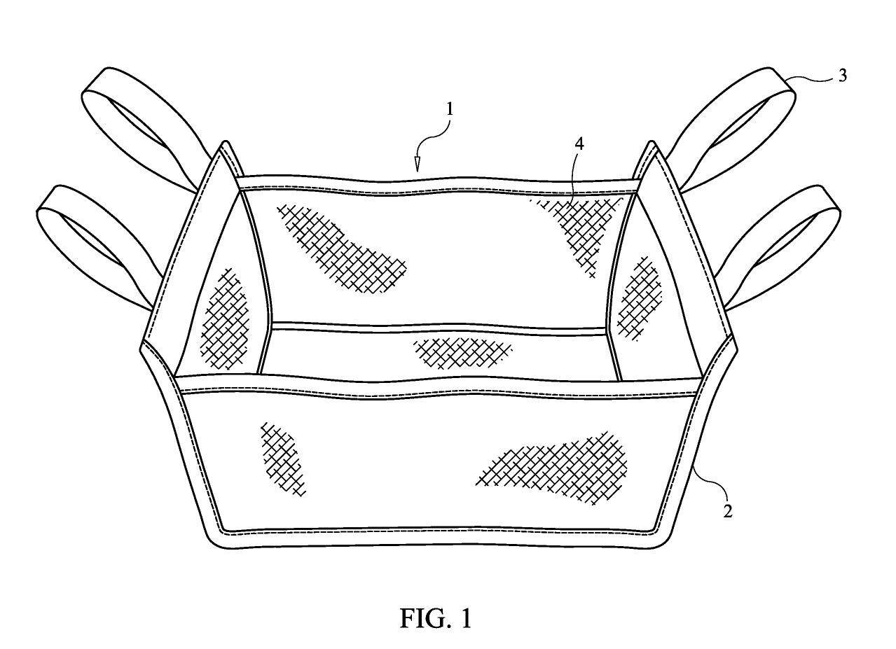

The bridle muzzle (1) provides an enclosure surrounding the mouth area of the horse which is easily attached and removed from the bridle and does not interfere with the bit or reins. Numerous configurations of the bridle muzzle are possible. In the embodiment depicted on FIG. 1, the bridle muzzle (1) includes a basket (2) with straps (3) to allow attachment to a bridle. The basket (2) material must include openings (4) sized to permit easy air flow so as not to restrict breathing, but not large enough to allow the passage of food for the horse. FIG. 1 accomplishes this by using a weave material with perforations throughout it. The opening on the top of the basket (2) is sized large enough to ensure it does not interfere with the bit on the bridle as existing eating baskets would do. The straps (3) shown on the figures are a hook and loop design to allow quick easy attachment and removal.

FIG. 1 depicts bridle muzzle (1) with a rectangular basket (2) and four straps (3). But numerous embodiments of the bridle muzzle (1) are envisioned. Other fastening mechanisms can be used instead of straps. The number and location of the fastening mechanisms can also be varied as desired. As long as the basket (2) is large enough to ensure no interference with the bit or control of the horse, the shape of the basket can be varied (e.g. oblong, circular, hexangular, etc).

FIG. 1 depicts a weave material for the basket (2) but the creation of any enclosure for the basket (2) which allows breathing and no interference with the bit or control of the horse can be used.

The straps in FIG. 1 utilize a hook and loop design for fastening but any means to fasten which allows easy fastening and easy quick removal is envisioned (e.g. snaps, magnetics, quick release knots).

The above illustrates various concepts, structures and techniques which are the subject of this patent. It will not become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

I claim:

1. A bridle comprising:
a basket with a large opening on top to surround the mouth area of a horse;
openings on all sides and bottom of the basket sized to allow air transfer for breathing but not eating; and
a minimum of two fastening mechanisms to secure the basket to the bridle;
wherein the basket is sized so that when fastened to the bridle it does not interfere with the horse's breathing, the bit in the horse's mouth and the control of the horse.

2. A bridle muzzle according to claim 1 wherein the basket is rectangular shape.

3. A bridle muzzle according to claim 1 wherein the fastening mechanism is straps.

4. A bridle muzzle according to claim 3 wherein the straps utilize a hook and loop design to fasten.

5. A bridle muzzle according to claim 1 wherein the basket is constructed from a weave material.

6. A bridle muzzle according to claim 1 wherein the fastening mechanism utilizes magnetics to secure the basket to the bridle.

7. A bridle muzzle according to claim 1 wherein the fastening mechanism utilizes a hook and loop material attached to the basket and the bridle to secure the basket to the bridle.

8. A bridle muzzle according to claim 1 wherein the basket has an oblong shape.

9. A bridle muzzle according to claim 1 wherein four fastening mechanisms are utilized to secure the basket to the bridle
